(19) United States
(12) Patent Application Publication
(10) Pub. No.: US 2016/0274858 A1
(43) Pub. Date: Sep. 22, 2016

(54) DISPLAYING ATTENUATING AUDIO SIGNAL LEVEL IN DELAYED FASHION

(71) Applicant: YAMAHA CORPORATION, Hamamatsu-shi (JP)

(72) Inventors: Shunichi KAMIYA, Hamamatsu-shi (JP); Kotaro TERADA, Hamamatsu-shi (JP)

(21) Appl. No.: 15/069,190

(22) Filed: Mar. 14, 2016

(30) Foreign Application Priority Data
Mar. 16, 2015 (JP) 2015-052411

(51) Int. Cl. G06F 3/16; G06F 3/0481

(52) U.S. Cl. CPC G06F 3/165; G06F 3/0481

(57) ABSTRACT

A disclosed apparatus includes: a setting section that variably sets a display delay time relative to attenuation variation of the level of the audio signal; and a control section that controls, in accordance with the display delay time set by the setting section, an attenuation style of the level of the audio signal to be displayed on the level meter. For example, per different type of supply source of the audio signal, display delay time information predefining a display delay time suitable for the type is stored in a memory. Based on the display delay time information stored in the storage section, the setting section sets a display delay time corresponding to the type of the supply source of the audio signal.

### BACKGROUND

The present invention relates to display control apparatus for controlling a level meter that displays a level of an audio signal and more particularly relates, for example, to a display control apparatus suitable for level meters provided on a mixing console that performs signal processing on audio signals of a plurality of channels.

In the fields of audio equipment such as audio recorders and audio amplifiers and video equipment such as video cameras and video reproduction (player) devices, it has heretofore been known to provide a level meter for monitoring a level of an audio signal input to the equipment. Among examples of such a level meter is one capable of not only displaying a level of an audio signal but also holding a peak value of the audio signal level for a given time period to display the thus-held peak value simultaneously with the audio signal level. Japanese Patent Application Laid-open Publication No. HEI-05-157578 (hereinafter referred to as “Patent Literature 1”) discloses variably setting, in accordance with user's preference and application of the apparatus in question, a time period for which a peak value of an audio signal is to be held.

Further, as a means for facilitating viewing of an audio signal level display on a level meter, it has been conventionally known to control attenuation variation of a level to be displayed on the level meter so that the displayed attenuation variation presents gentler variation, with a certain time constant, than actual attenuation variation of the level (see, for example, Patent Literature 1). As shown for example in FIG. 10 of Patent Literature 1, level variation 100 of an audio signal to be displayed on the level meter depicted by a solid line is displayed with a slight time delay from actual level variation 102 of the audio signal depicted by a broken line. Displaying the level variation in a gentler manner using the delaying scheme like this can secure a certain degree of visibility even for extreme level variation occurring within a short time period.

Generally, mixing consoles (hereinafter also referred to simply as “mixers”) which perform signal processing on audio signals of a plurality of channels include a plurality of level meters for displaying respective levels of audio signals of the plurality of channels (see, for example, an instruction manual for “YAMAHA DIGITAL MIXING CONSOLE PM5D/PM5DRH” published in 2004 by Yamaha Corporation which is available from the Internet at http://www2.yamaha.cajp/manual/pdf/pa/japan/mixers/PM5DJ1.pdf). An attenuation characteristic of an audio signal input to each of the channels differs depending on a type of musical instrument that is a supply source of the audio signal; for example, the attenuation characteristic differs between a percussion instrument and a stringed instrument. However, with the conventionally-known mixers, where a response speed to level variation of an audio signal is set identically among the level meters (i.e., all of the level meters are set uniformly at the same response speed to audio signal level variation), it is not possible to effect a level display reflecting differences between attenuation speeds corresponding to musical instrument types of the individual channels.

### SUMMARY OF THE INVENTION

In view of the foregoing prior art problems, it is an object of the present invention to provide an improved display control apparatus and an improved mixing console which permit a readily-recognizable level display taking account of a difference in attenuation characteristic between various audio signals.

In order to accomplish the above-mentioned object, the present invention provides an improved display control apparatus for controlling a level meter that displays a level of an audio signal, which comprises: a setting section configured to variably set a display delay time relative to attenuation variation of the level of the audio signal; and a control section configured to control, in accordance with the display delay time set by the setting section, an attenuation style of the level of the audio signal to be displayed on the level meter.

According to the present invention, a display delay time of the level meter relative to attenuation variation of a level (level attenuation variation) of an audio signal is variably set, and an attenuation style (i.e., in this case, a delay of display responsiveness to attenuation of the audio signal) of the level of the audio signal to be displayed on the level meter is controlled in accordance with the set display delay time. Thus, a response speed of the level meter at the time of the attenuation of the audio signal can be set at appropriate values corresponding to respective attenuation characteristics of various audio signals, so that the present invention can effect a readily-recognizable level display taking account of differences between attenuation characteristics of various audio signals. For example, by setting, for a type of audio signal that presents a quicker attenuation characteristic, a longer display delay time so that a level display of the audio signal can be effected with a delay emphasized, a user is allowed to readily visually recognize the level of the audio signal having the quicker attenuation characteristic originally.

In an embodiment of the invention, the display control apparatus further comprises a storage section that stores, for each of different types of supply sources of audio signals, display delay time information predefining a display delay time suitable for the type. Based on the display delay time information stored in the storage section, the setting section sets a display delay time corresponding to the type of supply source (supply source type) of the audio signal to be supplied to the level meter. The display delay time information suitable for the type is, for example, in the form of a value corresponding to an attenuation characteristic of the audio signal of the corresponding supply source type. In this way, the present invention can automatically set a display delay time suitable for a supply source type of each audio signal.

In one embodiment of the invention, the setting section sets a display delay time common to audio signals of a plurality of channels constituting a group. In this way, a display delay time can be set collectively for a plurality of channels constituting a group.

Further, in one embodiment of the invention, when the level of the audio signal attenuates, the control section is configured to perform control, in accordance with the display delay time, such that the level of the audio signal to be displayed on the level meter attenuates later than actual attenuation of the level of the audio signal. When the level of the audio signal increases, on the other hand, the control section is configured to perform control such that the level of the audio signal to be displayed on the level meter increases closely following the actual attenuation of the level of the audio signal.

According to another aspect of the present invention, there is provided an improved mixing console for controlling signal processing on audio signals of a plurality of channels, which comprises: a plurality of level meters provided in corresponding relation to the plurality of channels for displaying levels of the audio signals of corresponding ones of the channels; a setting section configured to variably set, for each of the channels, a display delay time relative to attenuation variation of the level (level attenuation variation) of the audio signal of the channel; and a control section configured to control, for each of the channels and in accordance with the display delay time set for the channel by the setting section, an attenuation style of the level of the audio signal of the channel to be displayed on the level meter of the channel.

Namely, according to the display control apparatus and the mixing console of the present invention, by slowing down display responsiveness of the level meters at the time of level attenuation of audio signals while taking account of a difference between attenuation characteristics of the audio signals, readily-recognizable level displays of the audio signals can be effected in accordance with respective attenuation characteristics. As a result, for example, the present invention allows the user to visually recognize the level of the audio signal having the quicker attenuation characteristic originally.

The present invention may be constructed and implemented not only as the apparatus invention discussed above but also as a method invention. Also, the present invention may be arranged and implemented as a software program for execution by a processor, such as a computer or DSP, as well as a non-transitory computer-readable storage medium storing such a software program.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

Certain preferred embodiments of the present invention will hereinafter be described in detail, by way of example only, with reference to the accompanying drawings, in which:

FIG. 1 is a block diagram showing an example construction of a display control apparatus according to an embodiment of the present invention, and FIG. 1B a block diagram showing an example construction of an embodiment of a mixing console of the present invention;

FIG. 2 is a block diagram showing an example electric hardware setup of the embodiment of the mixing console of the present invention;

FIG. 3 is a block diagram explanatory of an example construction for implementing a signal processing function in the embodiment of the mixing console of the present invention;

FIG. 4 is a block diagram showing an example detailed construction of a channel module in the embodiment of the mixing console of the present invention;

FIG. 5 is a diagram showing a channel view screen including a plurality of level meter images as examples of level meters provided in the embodiment of the mixing console of the present invention;

FIG. 6 is a diagram showing an example structure of display delay time information stored per type of audio signal and predefining a display delay time suitable for the type of audio signal;

FIG. 7 is a diagram showing an example data structure for storing, per channel, a response speed corresponding to a category in the embodiment of the mixing console of the present invention, which is more particularly explanatory of an example structure of channel data of the channel;

FIG. 8 is a flow chart showing an example operational sequence of level meter display control processing performed in the embodiment of the mixing console of the present invention;

FIG. 9 is a graph comparing actual level variation of an audio signal and level variation displayed on the level meter; and

FIG. 10 is explanatory of a conventionally-known technique, which is more particularly a graph comparing actual level variation of an audio signal and level variation displayed on a level meter.

### DETAILED DESCRIPTION

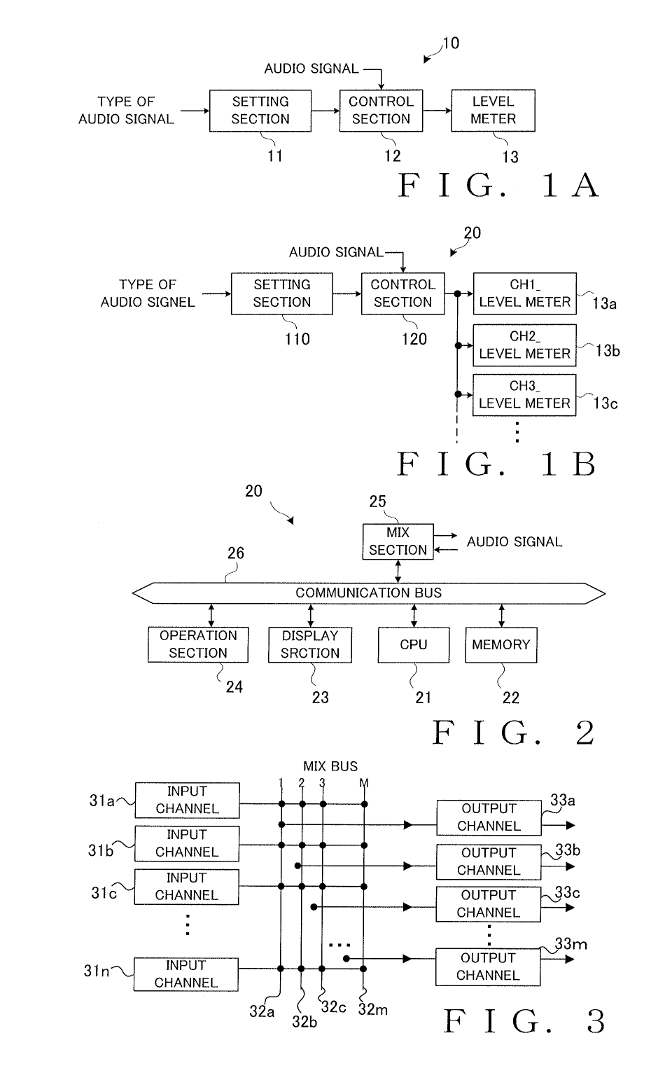

FIG. 1A is a block diagram showing an example construction of a display control apparatus 10 according to an embodiment of the present invention. The display control apparatus 10 shown in FIG. 1A is constructed to control a level meter 13 that displays a level of an audio signal. The level meter 13 employed here is in the form of LEDs, an LCD, an analog meter or the like and constructed to visibly display level variation of an audio signal in a continuous manner. In the case where the level meter 13 is in the form of a, LED array comprising a plurality of LED elements arranged in a generally shape or a generally band-shaped image displayed on an LCD, for example, an illumination width of the level meter 13 increases or decreases in response to level variation of an audio signal so that the level variation of the audio signal is displayed in a continuous manner. In the case where the level meter is in the form of an analog meter, level variation of an audio signal is displayed by swing or deflection widths of an indicator needle of the meter.

The display control apparatus 10 includes a setting section 11 that variably sets a display delay time of the level meter 13 relative to level attenuation variation of an audio signal either automatically or manually, and a control section 12 that, on the basis of the display delay time set by the setting section 11 and the level of the audio signal, controls a level value to be displayed on the level meter 13. With the construction for variably setting a display delay time, it is possible to adjust a response speed of the level meter 13 to actual level attenuation variation of the audio signal. As an example, the display control apparatus 10 is constructed to store, for each of different types of supply sources of audio signals, display delay time information predefining a display delay time suitable for the supply source type in a storage section (depicted at 22 in FIG. 2 to be described later). The display delay time information suitable for the supply source type is, for example, in the form of a value corresponding to an attenuation characteristic of the audio signal of the supply source type. In this case, the setting section 11 is capable of readily setting a suitable display delay time corresponding to a type of supply source of an audio signal, such as a musical instrument type. In this way, the control section 12 can control the level meter 13 in accordance with a response speed corresponding to a type of supply source, such as a musical instrument type, of an audio signal.

FIG. 1B is a block diagram showing an example construction for performing display control in an embodiment of a mixing console (hereinafter also referred to as “mixer”) 20 of the present invention. The mixer 20 is, for example, a digital mixer that performs signal processing on a plurality of channels solely through digital signal processing. The mixer 20 includes: level meters 13a, 13b, 13c, . . . (“CH1_LV meter”, “CH2_LV meter”, “CH3_LV meter”, . . . in the figure) that are provided in corresponding relation to the channels for displaying levels of audio signals of the corresponding channels; a setting section 110 that variably sets, for each of the channels, a display delay time of the level meter 13a, 13b, 13c, . . . relative to level attenuation variation of an audio signal; and a control section 120 that, on the basis of the display delay time set for each of the channels by the setting section 110 and the level of the audio signal, controls a level value to be displayed on the corresponding level meter 13a, 13b, 13c, . . . . As an example, for each of different types of supply sources of audio signals, the mixer 20 stores, in the memory or storage section (depicted at 22 in FIG. 2 to be described later), display delay time information predefining a display delay time suitable for the supply source type. The setting section 110 is capable of automatically readily setting, for each of the channels, a suitable display delay time corresponding, for example, to a type of musical instrument, which is a supply source of an audio signal, by reference to the storage section. In this way, the control section 120 can control the level meter 13a, 13b, 13c, . . . of each of the channels in accordance with a response time corresponding to a type of supply source of an audio signal, such as a musical instrument type, of the channel. In the specification, reference characters with suffix alphabetical letters and numerals like “13a”, “13b”, “13-1”, “13-2”, etc. are used in order to distinguish among a plurality of components or elements, such as the level meters, provided in the mixer 20; however, reference characters with numerals alone, such as “13”, are used where there is no need to distinguish among a plurality of components or elements provided in the mixer 20

FIG. 2 is a block diagram showing an example electric hardware setup of the embodiment of the mixer 20. The mixer 20 shown in FIG. 2 includes a central processing unit (CPU) 21, a memory 22, a display section 23, an operation section 24, and a signal processing section (MIX section) 25. These components 21 to 25 are interconnected via a communication bus 26, so that various control signals can be communicated between the CPU 21 and the components 22 to 25. Further, the MIX section 25 can input or output analog or digital audio signals from or to input equipment, such as a microphone and a reproduction device, or output equipment, such as an amplifier and a speaker.

The CPU 21 controls overall operation of the mixer 20 by executing various programs stored in the memory 22. The memory 22 not only non-volatilely stores various programs to be executed by the CPU 21 and various data to be referenced by the CPU 21, but also are used as a loading area for a program to be executed by the CPU 21 and as a working area for use by the CPU 21. The memory 22 may comprise a combination of various memory devices, such as a read-only memory (ROM), a random-access memory (RAM), a flash memory and a hard disk.

The display section 23, which comprises a display, related interface circuitry, etc., displays various information, based on display control signals given from the CPU 21, in various images, character trains, etc. The display section 23 includes the level meters 13 as shown in FIGS. 1A and 1B. The operation section 24 includes a plurality of manual operators (operating members), related interface circuitry, etc. A user of the mixer 20 uses various manual operators of the operation section 24 to perform operations for setting and changing various parameters. The CPU 21 acquires a detection signal corresponding to an input operation performed by the user on the operation section 24 or on the display (display section 23) and controls the operation of the mixer 20 on the basis of the acquired detection signal.

The MIX section 25 comprises, for example, a signal processing device virtually implemented, for example, by a DSP (Digital Signal Processor), the CPU 21 and software stored in the memory 22. The MIX section 25 executes a signal processing program to perform signal processing on one or more digital audio signals supplied from not-shown input equipment and outputs the thus-processed digital audio signals to not-shown output equipment. The signal processing performed by the MIX section 25 includes mixing processing for mixing a plurality of audio signals, and this signal processing is controlled on the basis of current values of a plurality of parameters stored in the memory 22.

FIG. 3 is a block diagram explanatory of a construction for implementing the signal processing function of the mixer 20. Operation of each element shown in FIG. 3 is performed solely through digital signal processing by the MIX section 25. The mixer 20 includes a plurality of input channel modules (“input channels” in the FIGS. 31a to 31n. The input channel modules 31a to 31n each receive an audio signal from a corresponding one of input ports (not shown), perform signal processing based on values of various parameters, and selectively output the thus-processed audio signal to any one or more of MIX buses 32a to 32m. The mixer 20 further includes a plurality of output channel modules 33a to 33m. Each of the output channel modules 33a to 33m corresponds to any one of the MIX buses 32a to 32m and performs signal processing, based on values of various channel-specific parameters, on the audio signal output from the corresponding MIX bus 32a-33m. The various signal processing performed by the individual channel modules includes, for example, tone volume level adjustment, equalizing, panning, impartment of various effects, etc. based on current values of various parameters stored in the memory 22.

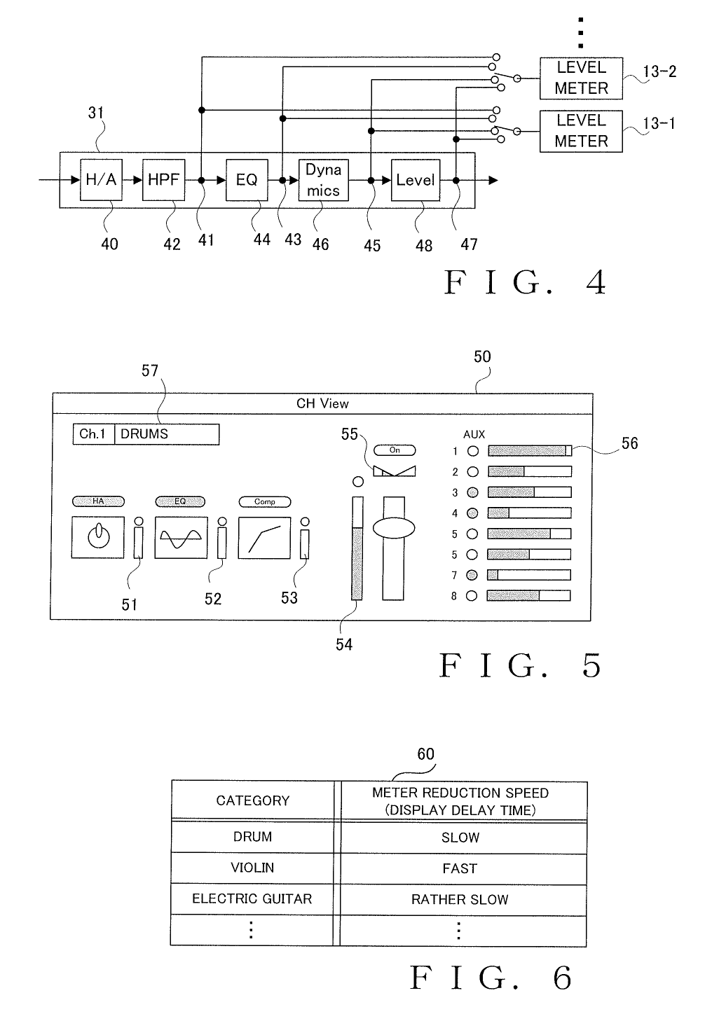

FIG. 4 is a block diagram showing an example detailed construction of the input channel module 31 as an example detailed construction of a representative one of the channel modules. The input channel module 31 includes as a plurality of signal processing elements: a head amplifier (“HA” in the FIG. 40; a high-pass filter (“HPF” in the FIG. 42; an equalizer (“EQ” in the FIG. 44; dynamics control (“Dynamics” in the FIG. 46 including a gate, a compressor, etc.; and tone volume level adjuster (“Level” in the FIG. 48. The input channel module 31 also includes a plurality of meter output points 41, 43, 45 and 47, and a signal indicative of a level of an audio signal taken out from a selected one of the meter output points 41, 43, 45 and 47 is output to each of the plurality of level meters 13-1, 13-2, . . . . The plurality of level meters 13-1, 13-2, . . . is a group of meters for effecting a level display related to an audio signal of one channel input to the input channel module 31 and corresponds to any one of the channel-specific level meters 13a, 13b, 13c, . . . shown in FIG. 1B (or the level meter 13 shown in FIG. 1A). Note that the meter output point may be provided at any suitable one or more positions on the channel module rather than at the four positions illustrated in FIG. 4.

Although not particularly shown, the output channel modules each include a plurality of signal processing elements and a plurality of meter output points associated with a plurality of level meters for executing a level display related to an audio signal input to the output channel module, similarly to the input channel module 31 shown in FIG. 4.

Further, FIG. 5 shows a plurality of level meters 51 to 56 displayed on a screen of a display (display section 23) in the form of an LCD, as examples of the level meter 13 provided on the mixer. A channel view screen (“CH View”) shown in FIG. 5 not only displays icons indicative of a head amplifier, an equalizer, a compressor, a tone-volume-level fader operator and a channel on/off switch, as specific signal processing elements of one channel selected by the user, but also displays the level-displaying level meters 51 to 55 provided near and in association with the above-mentioned signal processing elements. The level meters 51 to 54 display, for the audio signal of the currently selected channel, levels taken out from pre or post stages of the corresponding signal processing elements. The level meters 51 to 54 include respective peak meters. The level meter 55 displays a stereo output balance level of the currently selected channel. The level meters 51 to 55 are level meters (13-1, 13-2, . . . in FIG. 4) for displaying various levels of the audio signal of the currently selected channel. Further, eight level meters 56 corresponding to a plurality of channels are displayed on the channel view screen 50, and levels of audio signals of the corresponding channels are displayed on these level meters 56. These level meters 56, which display levels of audio signals of the plurality of channels, correspond to the level meters 13a, 13b, 13c, . . . shown in FIG. 1B. The level meters 56 also include AUX output ON/OFF displays of the corresponding channels.

The instant embodiment of the mixer 20 is constructed to variably set a display delay time of the level meter 13 per channel. Such variable display delay time setting is intended to effect channel-by-channel level displays with respective response speeds reflecting differences between attenuation speeds of audio signals of the channels. However, manually setting an appropriate display delay time per channel, for example, in accordance with a numerical value input by the user is troublesome and difficult. Thus, for each category indicative of a type of audio signal supply source (audio signal supply source type), display delay time information predefining a display delay time suitable for an audio signal of the supply source type is prestored in the memory 22, in order to automatically and readily perform the variable display delay time setting. In this specification, the term “category” is used to refer to one of categories of audio signal supply sources determined by classifying the audio signal supply sources in accordance with respective attenuation characteristics of audio signals. More specifically, the categories may be determined by classifying the audio signal supply sources (i.e., tone sources) in accordance with musical instrument types, such as drums, violin and electric guitar, or by classifying the tone sources in accordance with voice types, such as male voice, female voice, soprano and alto. As another example, the categories may be determined by classifying the audio signal supply sources in accordance with given aspects that can influence differences in characteristic among the audio signals, such as performers or players, genres of performance (e.g., theatrical play, opera, popular ballade performance and pops performance) or in accordance with environment of use of the mixer 20 (e.g., size of a room, outdoors or indoors and name of a hall where the mixer 20 is used).

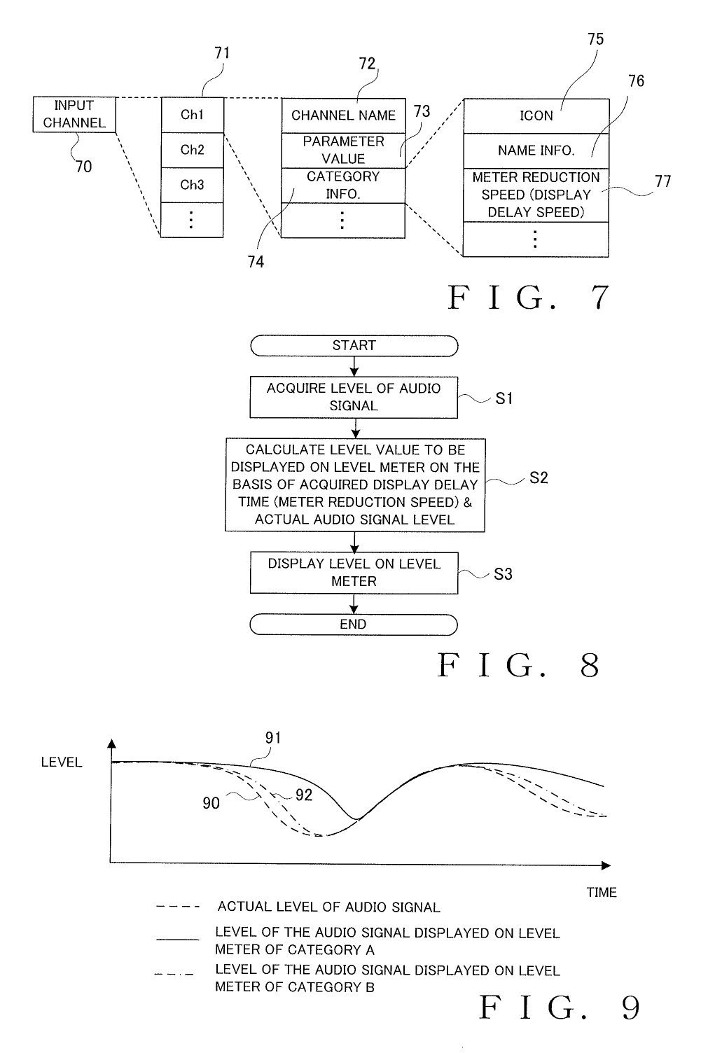

FIG. 6 shows an example structure of the display delay time information 60. In the illustrated example of FIG. 6, the display delay time is expressed as a response speed of the level meter 13 (level meters 51 to 56 in FIG. 5) to level attenuation variation of an audio signal, i.e. as “meter reduction speed” indicative of a speed or rate at which a swing or deflection width of the level meter decreases. In this specification, the term “display delay time” and the term “meter reduction speed” are used interchangeably.

As shown in FIG. 6, the display delay time information 60 is stored for each of the categories, such as drums, violin and electric guitar, and predefines a meter reduction speed (display delay time) suitable for the category. The meter reduction speed of each of the categories may be of a numerical value that represents the meter reduction speed, for example, in milliseconds. As another example, the value of the meter reduction speed of each of the categories may be represented by a variation rate of the meter reduction speed, i.e. a rate at which to slow down the meter reduction speed.

Further, in FIG. 6, the meter reduction speed for each of the categories indicates whether the meter reduction speed of the category is relatively fast or slow. For example, a drum performance tone has the characteristic that its attenuation speed is fast, and thus, if level display of a drum performance tone is effected closely following actual level attenuation variation, variation speed of the displayed level value tends to be too fast, which would result in poor visibility. Therefore, in the instant embodiment of the invention, the meter reduction speed is set slow for the drum category; in other words, the display delay time is set long for the drum category. Further, a violin performance tone has the characteristic that its attenuation speed is slow, and thus, the meter reduction speed is set fast for the violin category. In other words, the display delay time is set short for the violin category, so that the level display of the violin performance tone can be effected with a high follow-up characteristic (followability) relative to actual level attenuation variation.

FIG. 7 shows an example structure of input channel information 70 related to the input channels as an example structure of channel data stored in the memory 22. The input channel information 70 includes the respective channel data 71 of all of the input channels (“Ch1”, “Ch2”, “Ch3”, . . . in the figure) provided in the mixer 20. The channel data 71 of each of the channels includes: channel name data (“Ch name” in the FIG. 72 of the channel; current values of various parameters (“parameter values” in the figure) for controlling signal processing in the channel; and category information 74 indicative of a category set for the channel.

The category information 74 includes: image information 75 for displaying an icon indicative of the category; name information 76 indicative of a name of a musical instrument etc. including information indicative of a name of the category etc.; and a meter reduction speed (display delay time) 77 predefined for the category. The meter reduction speed 77 is set on the basis of the display delay time information 60 shown in FIG. 6. Namely, when the user has set a category for a particular one of channels, the CPU 21 acquires a value of the meter reduction speed corresponding the user-set category on the basis of the display delay time information 60 stored in the memory 22, and then, the CPU 21 writes the acquired value of the meter reduction speed into the category information 74 within the channel data 71 of the particular channel.

The user can set a category, for example, via a channel name display field 57 provided in a left upper portion of the channel view screen shown in FIG. 5. A channel name of a channel currently selected on the screen (“Ch1” in the figure) and a category name (“Drums” in the figure) set for that channel are displayed in the channel name display field 57 of FIG. 5. The user can select a new category by designating the category name displayed in the channel name display field 57. In response to the user's selection of such a new category, the CPU 21 changes the category information 74 of the channel data 71 of the currently selected channel in accordance with the newly selected category to thereby set a meter reduction speed 77 corresponding to the newly selected category. Setting the meter reduction speed 77 as above corresponds to the setting section 11 or 110 variably setting, per channel, a display delay time of a level meter relative to level attenuation variation of an audio signal. Thus, by merely performing a simple and easily-understandable operation of setting a category per channel, the user can set a display delay time suitable for a type indicative of an audio signal supply source of each of the channels. Note that the currently selected channel displayed on the screen can be changed to another channel if only the channel name in the channel name display field 57 is changed to another.

In one example, one category may be set collectively for individual channels belonging to one group. For example, a plurality of channels to which are input audio signals of a plurality of musical instruments, such as snare drum, kick, tom-tom and cymbals, constituting a drum set together constitute a group, and a drum category is set for the individual channels belonging to that group (i.e., for the plurality of musical instruments, such as snare drum, kick, tom-tom and cymbals, constituting the drum set). As an example, such a category predefines the number of the channels constituting the group and a display delay time common to the group. Thus, in this case, the CPU 21 (setting section 110) sets such a common display delay time collectively for the plurality of channels constituting the group by setting new category information 74 collectively for the plurality of channels in response to setting of the category. As another example, the category not only predefines the number of the channels constituting the group but also separately predefines a display delay time for each of the channels constituting the group. Stated differently, musical instrument types to be allocated to the individual channels of the group are determined in advance. In this case, the CPU 21 (setting section 110) sets separate meter reduction speeds (display delay times) for the individual channels constituting the group by setting new category information 74 collectively for the plurality of channels in response to setting of the category.

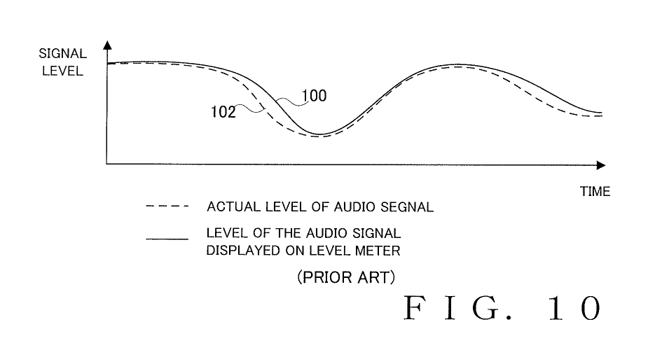

Next, a description will be given about level meter display control processing performed by the control section 12 or 120, with primary reference to FIG. 8 that is a flow chart showing an example operational sequence of the level meter display control processing. The level meter display control processing is performed through software processing by the CPU 21. The level meter display control processing shown in FIG. 8 is performed periodically, for example, at an appropriate triggering cycle of 30 times per second for each of the channels provided in the mixer 20 and for each of the level meters associated with the channels. First, at step S1, the CPU 21 acquires an actual level of an audio signal to be displayed on the level meter of each of the channels. Then, at step S2, the CPU 21 acquires a meter reduction speed (display delay time) by reference to the channel data 71 of the channel stored in the memory 22 and then calculates, on the basis of the acquitted display delay time and the actual level acquired at step S1 above, a level value to be displayed on the level meter. At next step S3, the CPU 21 effects a level display on the level meter of the channel on the basis of the level value calculated at step S2.

FIG. 9 is a graph comparing an actual level 90 of an audio signal (depicted by broken line in FIG. 9) and level variation displayed on a level meter (i.e., meter value). The vertical axis in FIG. 9 represents the level, while the horizontal axis in FIG. 9 represents the time. A level value 91 depicted by solid line in FIG. 9 is indicative of a level 90 of an audio signal displayed on the level meter of a channel set at Category A for which the display delay time is long (i.e., the meter reduction speed is slow). In this case, the level value 91 attenuates later than variation of the actual level 90 (actual variation of the level 60). For example, if a long display delay time like that of Category A is applied to an audio signal of a drum or the like having a fast level attenuation speed, attenuation of a displayed level on the level meter can be visually recognized appropriately even where actual level attenuation is rapid or sharp. A level value 92 indicated by a one-dot-dash line, on the other hand, is indicative of the level 90 of the audio signal displayed on the level meter of a channel set at Category B for which the display delay time is short (i.e., the meter reduction speed is fast). In this case, the level value 92 attenuates substantially closely following the actual variation of the level 90. A short display delay time like that of Category B is applied to a type of audio signal having a slow level attenuation speed like that of a violin, in which case the level meter presents response as fast as the auditory sense of the user.

When the actual level 90 of the audio signal attenuates, the level values 91 and 92 attenuate later than the actual level variation with respective display delay times corresponding to their categories, as shown in FIG. 9. When the actual level 90 of the audio signal increases, on the other hand, the level values 91 and 92 increase substantially closely following the actual level variation with shorter delay times than when the actual level 90 of the audio signal attenuates. Namely, when the actual level 90 of the audio signal attenuates, the control section 12 performs control based on the display delay time corresponding to the category. When the actual level 90 of the audio signal increases, on the other hand, the control section 12 may control the level value to present increasing variation, substantially closely following the increasing variation of the actual level 90, with a shorter delay time than when the actual level 90 of the audio signal attenuates, without performing the control based on the display delay time corresponding to the category. For example, in the display control processing of FIG. 8, the CPU 20 may hold the level acquired at step S1 for each of the level meters of the individual channels in the last execution of the display control processing, and the CPU 20 may compare the last level and the currently acquired level so that the CPU 20 can determine whether the level of the audio signal increases or decreases from the last level. When the level of the audio signal increases from the last level as determined through the comparison, the CPU 20 performs the display control at step S3 above on the basis of the display delay time calculated at step S2 above. When the level of the audio signal increases from the last level as determined through the comparison, on the other hand, the CPU 20 performs the display control at step S3 on the basis of the acquired level alone without considering the display delay time. In this manner, appropriate visibility of the level display on the level meter at the time of level attenuation of an audio signal can be secured. At the time of level increase of an audio signal, on the other hand, a good-response level display can be effected in response to the level increase. As a modification, when the level of the audio signal increases, the display control of step S3 above may be performed on the basis of a short display delay time (e.g., 300 milliseconds that is a display delay time similar to a response speed of an ordinary hardware level meter) common to all of the level meters of all of the channels.

Whereas the present invention has been described above in relation to the preferred embodiment, the present invention is not limited to the above-described preferred embodiment and may be modified variously within the scope of the technical idea disclosed in the appended claims, the specification and the drawings. For example, the level meter employed in the present invention is not limited to the type where a level is displayed by a band-shaped display width as illustratively indicated on the screen of FIG. 5 and may be of any other desired type, such as an analog meter type, e.g., a VU meter, where a level is displayed by a swing or deflection width of an indicator needle as described above, a type where increasing/decreasing level variation is displayed by intensity of lighting luminance of a lamp-like display, or a type where a level is displayed by a numerical value.

Furthermore, the application of the display control apparatus 10 of the present invention is not limited to hardware mixers like the above-described mixer 20, and the display control apparatus 10 of the present invention is also applicable, for example, to level displays in DAWs (Digital Audio Workstations) designed for performing music production on a personal computer, and more particularly to level displays on recording, editing and mixing screens displayed on a display device through execution of software in such DAWs. Furthermore, the display control apparatus 10 of the present invention is applicable to any devices and apparatus, other than mixers like the mixer 20, which include a level meter for displaying a level of an audio signal, such as recording apparatus and video cameras.

This application is based on, and claims priority to, JP PA 2015-052411 filed on 16 Mar. 2015. The disclosure of the priority application, in its entirety, including the drawings, claims, and the specification thereof, are incorporated herein by reference.

What is claimed is:

1. A display control apparatus for controlling a level meter that displays a level of an audio signal, comprising:
a setting section configured to variably set a display delay time relative to attenuation variation of the level of the audio signal; and
a control section configured to control, in accordance with the display delay time set by the setting section, an attenuation style of the level of the audio signal to be displayed on the level meter.

2. The display control apparatus as claimed in claim 1, which further comprises a storage section that stores, for each of different types of supply sources of audio signals, display delay time information predefining a display delay time suitable for the type, and
wherein, based on the display delay time information stored in the storage section, the setting section sets a display delay time corresponding to the type of the supply source of the audio signal to be supplied to the level meter.

3. The display control apparatus as claimed in claim 1, wherein the setting section is configured to set a display delay time common to audio signals of a plurality of channels constituting a group.

4. The display control apparatus as claimed in claim 1, wherein, when the level of the audio signal attenuates, the control section is configured to perform control, in accordance with the display delay time, such that the level of the audio signal to be displayed on the level meter attenuates later than actual attenuation of the level of the audio signal, but when the level of the audio signal increases, the control section is configured to perform control such that the level of the audio signal to be displayed on the level meter increases following the actual attenuation of the level of the audio signal.

5. A display control method for controlling a level meter that displays a level of an audio signal, comprising:
variably setting, by a processor, a display delay time relative to attenuation variation of the level of the audio signal; and
controlling, by the processor, in accordance with the variably-set display delay time, an attenuation style of the level of the audio signal to be displayed on the level meter.

6. A non-transitory computer-readable storage medium containing a group of instructions executable by a processor for performing a display control method for controlling a level meter that displays a level of an audio signal, the display control method comprising:
variably setting a display delay time relative to attenuation variation of the level of the audio signal; and
controlling, in accordance with the variably-set display delay time, an attenuation style of the level of the audio signal to be displayed on the level meter.

7. A mixing console for controlling signal processing on audio signals of a plurality of channels, comprising:
a plurality of level meters provided in corresponding relation to the plurality of channels for displaying levels of the audio signals of corresponding ones of the channels;
a setting section configured to variably set, for each of the channels, a display delay time relative to attenuation variation of the level of the audio signal of the channel; and
a control section configured to control, for each of the channels and in accordance with the display delay time set for the channel by the setting section, an attenuation style of the level of the audio signal of the channel to be displayed on the level meter of the channel.

8. The mixing console as claimed in claim 7, which further comprises a storage section that stores, for each of different types of supply sources of audio signals, display delay time information predefining a display delay time suitable for the type, and
wherein, for each of the channels and based on the display delay time information stored in the storage section, the setting section sets a display delay time corresponding to the type of the supply source of the audio signal.

9. The mixing console as claimed in claim 7, wherein the setting section sets a display delay time common to audio signals of a plurality of channels constituting a group.

10. A display control apparatus for controlling a level meter that displays a level of an audio signal, comprising:
a storage medium storing a program; and
a processor for executing the program, the processor, when executing the program, configured for:
variably setting a display delay time relative to attenuation variation of the level of the audio signal; and
controlling, in accordance with the set display delay time, an attenuation style of the level of the audio signal to be displayed on the level meter.

11. A mixing console for controlling signal processing on audio signals of a plurality of channels, comprising:
a plurality of level meters provided in corresponding relation to the plurality of channels for displaying levels of the audio signals of corresponding ones of the channels;
a storage medium storing a program; and
a processor for executing the program, the processor, when executing the program, configured for:
variably setting, for each of the channels, a display delay time relative to attenuation variation of the level of the audio signal of the channel; and
controlling, for each of the channels and in accordance with the display delay time set for the channel, an attenuation style of the level of the audio signal of the channel to be displayed on the level meter of the channel.
